(19) United States
(12) Patent Application Publication
(10) Pub. No.: US 2020/0115872 A1
(43) Pub. Date: Apr. 16, 2020

(54) MODULAR STEEL WIREGUARD WITH GUSSETS

(71) Applicant: Caterpillar Inc., Deerfield, IL (US)

(72) Inventor: Daniel J. Pierce, Deadwood, SD (US)

(73) Assignee: Caterpillar Inc., Deerfield, IL (US)

(21) Appl. No.: 16/160,049

(22) Filed: Oct. 15, 2018

(51) Int. Cl. E02D 3/026; B60B 15/26

(52) U.S. Cl. CPC E02D 3/0265; B60B 2900/721; B60Y 2200/413; B60B 15/266

(57) ABSTRACT

A wireguard subassembly includes a first circumferential segment defining a proximate end including a ledge at least partially defining a notch; a second circumferential segment defining a distal end disposed adjacent the proximate end of the first circumferential segment; and a gusset member including a tab at least partially disposed in the notch on top of the ledge.

### TECHNICAL FIELD

The present disclosure relates to compactor wheels using to compact trash and debris in landfills, and the like. Specifically, the present disclosure relates to a modular steel wireguard with gussets that may be attached to a compactor wheel to help prevent the fouling of an axle to which the compactor wheel is attached.

### BACKGROUND

A common problem with landfill compactors is trapping debris around the wheels. As the compactor continues to move, the debris moves and gets wrapped around the axles. This debris, if not removed, can damage axle assembly and can quickly degrade axle seals. This may necessitate maintenance and undesirable downtime for the compactor.

Various solutions have been previously developed to help prevent the fouling of the axle. For example, a wireguard may be employed that helps prevent debris from entering the opening disposed between the compactor wheel and the axle.

U.S. RE43,381 to Brockway discloses an axle guard system which prevents, or at least substantially inhibits, cable, rope, wire and other refuse and debris from wrapping around the axle of a compaction machine, behind a compactor wheel mounted on the axle, during the operation of the compaction machine in compacting refuse. The compaction machine is of the type used, for example, in landfills or transfer facilities to compact (i.e., increase the density of) the refuse disposed therein. The compactor wheel comprises a hub mountable to the compaction machine axle, a rim mounted around the outer circumference of the hub, a plurality of cleats mounted to the face of the rim, and the axle guard system. The axle guard system can comprise at least one circumferential barrier extending above the face and adjacent the inner circumferential edge of the rim and/or a cleat-free area extending widthwise from the inner circumferential edge of the rim and across the rim toward the outer circumferential edge of the rim (see the Abstract of Brockway).

However, continuous improvement of such barriers so that they may be easily assembled and attached to the compactor wheel in a robust manner is warranted.

### SUMMARY

A compactor wheel assembly according to an embodiment of the present disclosure may comprise a hub portion including an axle attachment portion; a rim portion including an outer circumferential surface defining a radial direction, a circumferential direction, and a longitudinal axis; a plurality of cleats attached to the outer circumferential surface of the rim portion; and a wireguard attached to the rim portion, the wireguard extending circumferentially about the axle attachment portion being spaced radially away from the axle attachment portion and defining an outer diameter, a rear radially extending surface, and a front radially extending surface. Hardfacing may be applied to the outer diameter, to at least a portion of the front radially extending surface adjacent the outer diameter, and to at least a portion of the rear radially extending surface adjacent the outer diameter.

A wireguard subassembly according to an embodiment of the present disclosure may comprise a first circumferential segment defining a proximate end including a ledge at least partially defining a notch, a second circumferential segment defining a distal end disposed adjacent the proximate end of the first circumferential segment, and a gusset member including a tab at least partially disposed in the notch on top of the ledge.

A wireguard kit according to an embodiment of the present disclosure may comprise a plurality of identically configured gusset members, each gusset member including a top free surface, a bottom attachment surface, a rear surface, and a rearwardly extending tab; and a plurality of identically configured circumferential segments, each circumferential segment defining a notch configured to receive a rearwardly extending tab.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a front oriented perspective view of a compactor wheel including a wireguard with gussets according to an embodiment of the present disclosure.

FIG. 2 is a rear oriented perspective view of the compactor wheel of FIG. 1.

FIG. 3 is an enlarged detail view of the compactor wheel of FIG. 2 showing a circumferential segment and a gusset mating with the circumferential segment removed from the compactor wheel for enhanced clarity.

FIG. 4 is similar to FIG. 3 except that a second circumferential segment is shown mating with the first circumferential segment and the gusset.

FIG. 5 is similar to FIG. 4 except that welds used to attach the circumferential segments and gusset together and to the compactor wheel are shown.

FIG. 6 illustrates the wire guard of FIG. 2 removed from the compactor wheel of FIG. 2 and also depicts hardfacing placed on the top edges of the wireguard.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

Various embodiments of a compactor wheel assembly, a wireguard subassembly, and a wireguard kit according to various aspects of the present disclosure will now be described. In some embodiments, the various components are made from steel, allowing them to be durable and to be welded together.

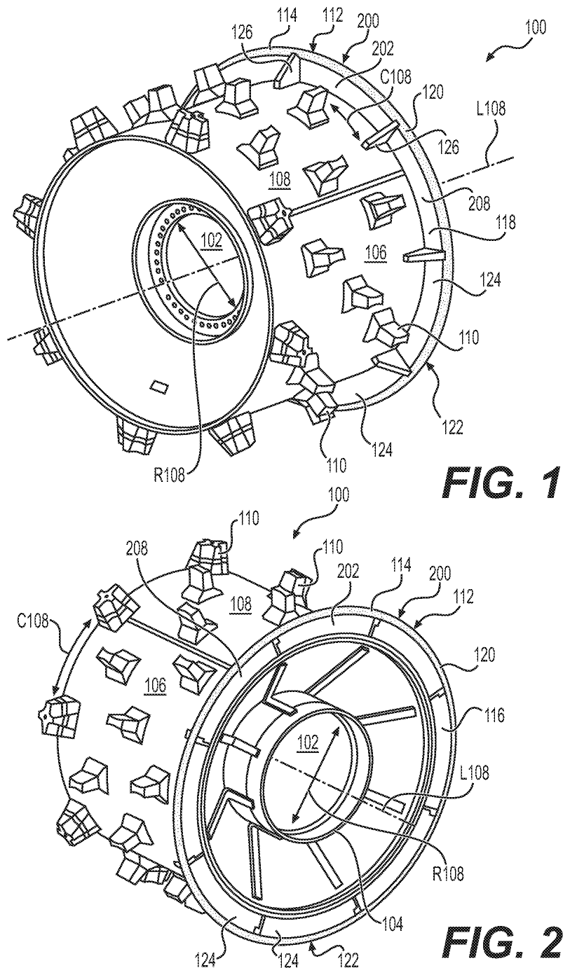

Looking at FIGS. 1 thru 6, a compactor wheel assembly 100 according to an embodiment of the present disclosure may comprise a hub portion 102 including an axle attachment portion 104, and a rim portion 106 including an outer circumferential surface 108 defining a radial direction R108, a circumferential direction C108, and a longitudinal axis L108. A plurality of cleats 110 may be attached to the outer circumferential surface 108 of the rim portion 106.

In addition, a wireguard 112 may be attached to the rim portion 106 axially proximate the axle attachment portion 104. The wireguard 112 may extend circumferentially about the axle attachment portion 104 being spaced radially away from the axle attachment portion 104. The wireguard 112 may also define an outer diameter 114, a rear radially extending surface 116, and a front radially extending surface 118.

As best understood with reference to FIGS. 1 and 6, hardfacing 120 may be applied to the outer diameter 114, to at least a portion of the front radially extending surface 118 adjacent the outer diameter 114, and to at least a portion of the rear radially extending surface 116 adjacent the outer diameter 116.

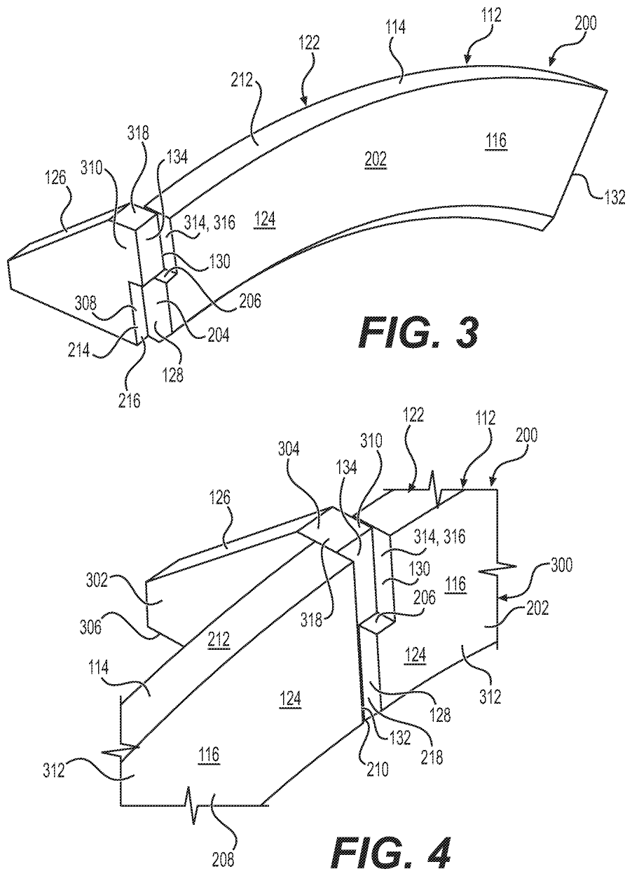

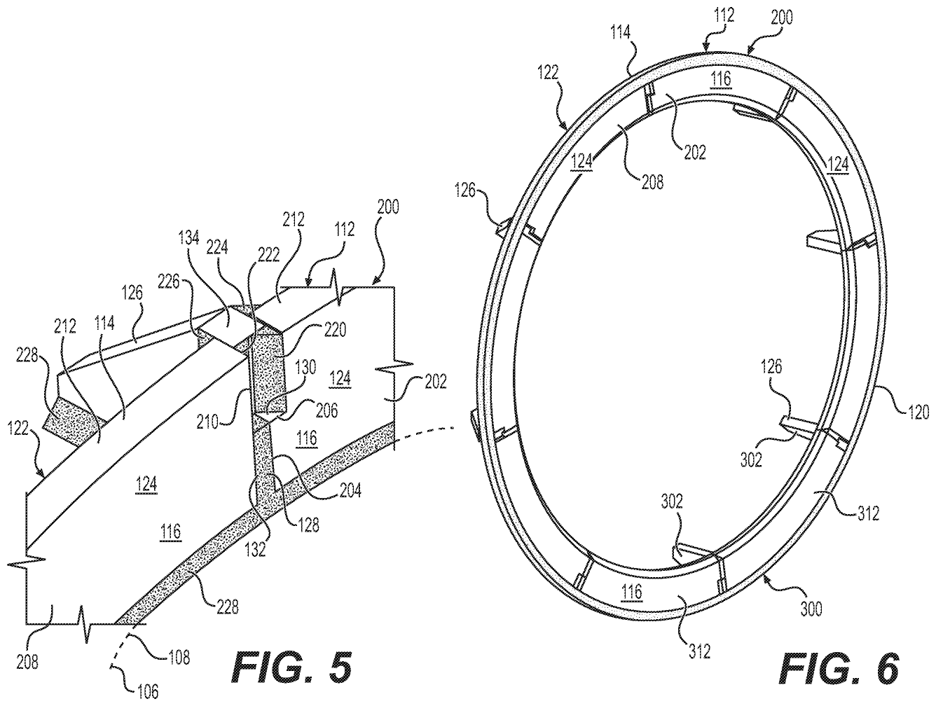

Focusing on FIGS. 3 thru 6, the wireguard 112 is a subassembly 122 including a plurality of circumferential segments 124 and a plurality of gusset members 126. Each of the plurality of gusset members 126 may be attached to two of the plurality of circumferential segments 124 (see FIG. 5). Also, each one of the plurality of circumferential segments 124 are attached to another one of the plurality of circumferential segments 124 and to the rim portion 106.

Looking at FIGS. 3 thru 5, each one of the plurality of circumferential segments 124 includes a first circumferential end 128 defining a notch 130 and a second circumferential end 132 lacking a notch. The notch 130 may extend from the outer diameter 114. Other configurations are possible. Each one of the plurality of gusset members 126 may include a tab 134 configured to fit within the notch 130.

As best seen in FIGS. 1, 2 and 6, the subassembly 122 includes 8 circumferential segments 124 and 8 gusset members 126. Other configurations and number of components are possible. As shown in FIG. 5, the gusset members 126 are welded to the circumferential segments 124 and to the rim portion 106, and the circumferential segments 124 are welded to each other and the rim portion 106. Other methods of attachment are possible including fastening, etc.

A wireguard subassembly 200 according to an embodiment of the present disclosure will now be discussed referring to FIGS. 1 thru 6. The wireguard subassembly 200 may comprise a first circumferential segment 202 defining a proximate end 204 including a ledge 206 at least partially defining a notch 130, and a second circumferential segment 208 defining a distal end 210 disposed adjacent the proximate end 204 of the first circumferential segment 202. The subassembly 200 may further comprise a gusset member 126 including a tab 134 at least partially disposed in the notch 130 on top of the ledge 206 (i.e. the tab 134 contacts or is slightly above the ledge 206). The distal end 210 lacks a notch. This may not be the case in other embodiments.

The first circumferential segment 202 may define a top circumferential surface 212 and the notch 130 may extend downwardly from the top circumferential surface 212. Similarly, the gusset member 126 may define a bottom notch 214 that is configured to receive the ledge 206 of the first circumferential segment 202 and may include an abutment surface 216 that at least partially defines the bottom notch 214.

The second circumferential segment 208 may be spaced circumferentially away from the first circumferential segment 202, forming a gap 218. In some embodiments, the first and the second circumferential segments 202, 208 contact the tab 134 (i.e. the first and the second circumferential segments 202, 208 touch or nearly touch the tab 134).

Focusing on FIG. 5, a first fillet weld 220 may be disposed in the notch 130 attaching the tab 134 to the first circumferential segment 202, and a second fillet weld 222 may be disposed in the notch 130, attaching the tab 134 to the second circumferential segment 208. The tab 134 may be recessed axially from rear radially extending surface 118, providing room for the welds and protection for the welds.

Additional welds may be provided in some embodiments, such as a third fillet weld 224 disposed outside of the notch 130 attaching the first circumferential segment 202 to the tab 134, and a fourth fillet weld 226 disposed outside of the notch 130, attaching the second circumferential segment 208 to the tab 134. These welds 224, 226 may be on the front radially extending surface.

A wireguard kit 300 according to yet another embodiment may be provided as follows. The kit 300 may comprise a plurality of identically configured gusset members 302, each gusset member including a top free surface 304, a bottom attachment surface 306, a rear surface 308, and a rearwardly extending tab 310. The kit 300 may further comprise a plurality of identically configured circumferential segments 312, each circumferential segment 312 defining a notch 314 configured to receive a rearwardly extending tab 310.

In some embodiments, each notch 314 is a top notch 316 and each tab 310 is a top tab 318.

Any of the configurations, materials, material properties, and dimensions mentioned herein may be altered in various embodiments of the present disclosure to have different values or characteristics than what has been specifically mentioned herein or shown in the drawings.

### INDUSTRIAL APPLICABILITY

In practice, a compactor wheel assembly, a wireguard subassembly, and/or a wireguard kit bearing according to any embodiment described herein may be sold, bought, manufactured or otherwise obtained in an OEM (original equipment manufacturer) or after-market context.

In various embodiments, the gussets may interlock into the wireguard segments to aid in fixturing and weld preparation. Gussets may also aid in fore/aft traction. Once welded on the wheel, hardfacing material may be applied to OD and 1″ down both sidewalls to aid in increasing the wear life.

Various assembly techniques or methods may be employed for creating the compactor wheel assembly and the wireguard subassembly according to various embodiments of the present disclosure.

For example, an assembler may install a segment 20 mm from the inner edge of the outer drum of the wheel. The assembler could then tack the segment, then place one gusset into the notches on the end of the segment and then align the next segment. Tacking and fitting all segments and gussets may continuing until the wireguard subassembly is formed all the way around the wheel. At that point, the welder may stringer (via bottom weld 228) all of the gussets and segments to the outer drum of the wheel.

Alternatively, the aforementioned method may be accomplished on a mandrel before to create the wireguard subassembly before attaching it the compactor wheel. Hence, the subassembly may be sold as a retrofit or replacement component. Or, the kit or the subassembly may be assembled in the field or onsite before being attached to the wheel, etc.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A compactor wheel assembly comprising:
a hub portion including an axle attachment portion;
a rim portion including an outer circumferential surface defining a radial direction, a circumferential direction, and a longitudinal axis;
a plurality of cleats attached to the outer circumferential surface of the rim portion; and
a wireguard attached to the rim portion, the wireguard extending circumferentially about the axle attachment portion being spaced radially away from the axle attachment portion and defining an outer diameter, a rear radially extending surface, and a front radially extending surface;
wherein hardfacing is applied to the outer diameter, to at least a portion of the front radially extending surface adjacent the outer diameter, and to at least a portion of the rear radially extending surface adjacent the outer diameter.

2. The compactor wheel assembly of claim 1 wherein the wireguard is a subassembly including a plurality of circumferential segments and a plurality of gusset members.

3. The compactor wheel assembly of claim 2 wherein each of the plurality of gusset members are attached to two of the plurality of circumferential segments.

4. The compactor wheel assembly of claim 3 wherein each one of the plurality of circumferential segments are attached to another one of the plurality of circumferential segments and to the rim portion.

5. The compactor wheel assembly of claim 4 wherein each one of the plurality of circumferential segments includes a first circumferential end defining a notch and a second circumferential end lacking a notch.

6. The compactor wheel assembly of claim 5 wherein the notch extends from the outer diameter.

7. The compactor wheel assembly of claim 6 wherein each one of the plurality of gusset members includes a tab configured to fit within the notch.

8. The compactor wheel assembly of claim 2 wherein the subassembly includes 8 circumferential segments and 8 gusset members.

9. The compactor wheel assembly of claim 4 wherein gusset members are welded to the circumferential segments and to the rim portion, and the circumferential segments are welded to each other and the rim portion.

10. A wireguard subassembly comprising:
a first circumferential segment defining a proximate end including a ledge at least partially defining a notch;
a second circumferential segment defining a distal end disposed adjacent the proximate end of the first circumferential segment; and
a gusset member including a tab at least partially disposed in the notch on top of the ledge.

11. The wireguard subassembly of claim 10 wherein the distal end lacks a notch.

12. The wireguard subassembly of claim 10 wherein the first circumferential segment defines a top circumferential surface and the notch extends downwardly from the top circumferential surface.

13. The wireguard subassembly of claim 10 wherein the gusset member defines a bottom notch that is configured to receive the ledge of the first circumferential segment.

14. The wireguard subassembly of claim 13 wherein the gusset member includes an abutment surface that at least partially defines the bottom notch.

15. The wireguard subassembly of claim 10 wherein the second circumferential segment is spaced circumferentially away from the first circumferential segment.

16. The wireguard subassembly of claim 15 wherein the first and the second circumferential segments contact the tab.

17. The wireguard subassembly of claim 16 further comprising a first fillet weld disposed in the notch attaching the tab to the first circumferential segment, a second fillet weld disposed in the notch, attaching the tab to the second circumferential segment.

18. The wireguard subassembly of claim 17 further comprising a third fillet weld disposed outside of the notch attaching the first circumferential segment to the tab, a fourth fillet weld disposed outside of the notch attaching the second circumferential segment to the tab.

19. A wireguard kit comprising:
a plurality of identically configured gusset members, each gusset member including a top free surface, a bottom attachment surface, a rear surface, and a rearwardly extending tab; and
a plurality of identically configured circumferential segments, each circumferential segment defining a notch configured to receive a rearwardly extending tab.

20. The wireguard kit of claim 19 wherein each notch is a top notch and each tab is a top tab.
